(19) United States
(12) Patent Application Publication
(10) Pub. No.: US 2026/0181706 A1
(43) Pub. Date: Jun. 25, 2026

(54) COMMUNICATION METHOD, USER EQUIPMENT, AND NETWORK NODE

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/543,472

(22) Filed: Feb. 18, 2026

Related U.S. Application Data
(63) Continuation of application No. PCT/JP2024/028543, filed on Aug. 8, 2024.

(30) Foreign Application Priority Data
Aug. 18, 2023 (JP) 2023-133587

(51) Int. Cl. H04W 74/0833; H04W 76/27

(52) U.S. Cl. CPC H04W 74/0833; H04W 76/27

(57) ABSTRACT

A communication method executed by a user equipment configured to communicate with a network of a mobile communication system includes the steps of: performing slice-based control of at least one of slice-based cell reselection that determines a frequency priority in consideration of a network slice or slice-based random access that selects a random access channel (RACH) configuration in consideration of the network slice; storing log information indicating a result of access to a network based on the slice-based control; and transmitting the log information to the network after connection to the network.

### RELATED APPLICATIONS

The present application is a continuation based on PCT Application No. PCT/JP2024/028543, filed on Aug. 8, 2024, which claims the benefit of Japanese Patent Application No. 2023-133587 filed on Aug. 18, 2023. The content of which is incorporated by reference herein in their entirety.

### TECHNICAL FIELD

The present disclosure relates to a communication method, a user equipment, and a network node used in a mobile communication system.

### BACKGROUND

In the Third Generation Partnership Project (3GPP) (trade name; the same applies hereinafter), which is a standardization project for mobile communication systems, a study has been conducted to apply an artificial intelligence or a machine learning (also referred to as “Artificial Intelligence (AI) or Machine Learning (ML)”) technology to an air interface in a mobile communication system.

### CITATION LIST

### Non-Patent Literature

Non-Patent Document 1: 3GPP Technical Report: TR 38.843 V0.1.0 (2023-05), “Study on Artificial Intelligence (AI)/Machine Learning (ML) for NR Air Interface (Release 18)”

### SUMMARY

In a first aspect, a communication method is a method executed by a user equipment configured to communicate with a network of a mobile communication system. The communication method includes the steps of: performing slice-based control of at least one of slice-based cell reselection that determines a frequency priority in consideration of a network slice or slice-based random access that selects a random access channel (RACH) configuration in consideration of the network slice; storing log information indicating a result of access to the network based on the slice-based control; and transmitting the log information to the network after connection to the network.

In a second aspect, a user equipment is an apparatus configured to communicate with a network of a mobile communication system. The user equipment includes: a controller configured to perform slice-based control of at least one of slice-based cell reselection that determines a frequency priority in consideration of a network slice or slice-based random access that selects a random access channel (RACH) configuration in consideration of the network slice, the controller being configured to store log information indicating a result of access to the network based on the slice-based control; and a transmitter configured to transmit the log information to the network after connection to the network.

In a third aspect, a network node is a node configured to communicate with a user equipment in a mobile communication system. The network node includes a receiver configured to receive, from a user equipment that has performed slice-based control of at least one of slice-based cell reselection that determines a frequency priority in consideration of a network slice or slice-based random access that selects a random access channel (RACH) configuration in consideration of the network slice, log information indicating a result of access to the network based on the slice-based control.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration example of a gNB (network node) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a functional block configuration of the AI/ML technology in the mobile communication system according to an embodiment.

FIG. 7 is a diagram for describing an overview of a network slicing technology.

FIG. 8 is a diagram illustrating an overview of operations of the UE in the mobile communication system according to an embodiment.

FIG. 9 is a diagram illustrating an example of a first operation pattern according to an embodiment.

FIG. 10 is a diagram illustrating an example of a second operation pattern according to an embodiment.

### DESCRIPTION OF EMBODIMENTS

Self-Organizing Networks (SON) are conceivable as a use case of the AI/ML technology. In particular, by applying the AI/ML technology to a network slicing technology, various parameters related to a network slice can be optimized by the AI/ML. However, a problem with such optimization is that no technology for a network to collect for the optimization is established, leading to difficulty in performing optimization related to the network slice.

The present disclosure provides performing optimization related to a network slice in a mobile communication system.

According to an embodiment, a mobile communication system is described with reference to the drawings. In the description of the drawings, the same or similar parts are denoted by the same or similar reference signs.

### (1) Configuration of Mobile Communication System

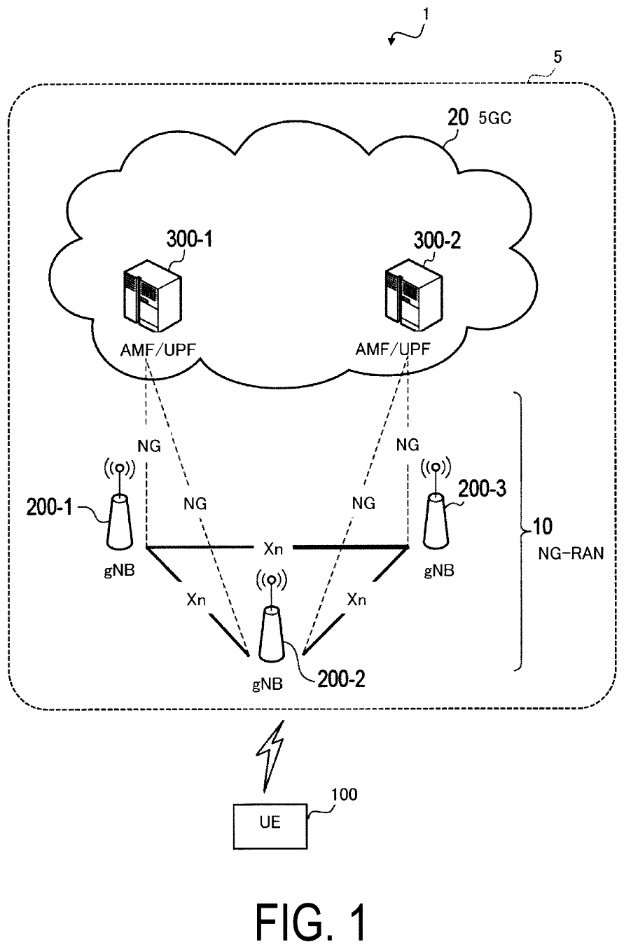

First, a configuration of a mobile communication system according to an embodiment is described. FIG. 1 is a diagram illustrating a configuration of a mobile communication system 1 according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1. The UE 100 performs wireless communication with the network 5.

The UE 100 is a mobile wireless communication apparatus. The UE 100 may be any apparatus as long as the UE 100 is used by a user. Examples of the UE 100 include a mobile phone terminal (which may be a smartphone) or a tablet terminal, a notebook PC, a communication module (which may be a communication card or a chipset), a sensor or an apparatus provided on the sensor, a vehicle or an apparatus (Vehicle UE) provided on the vehicle, and a flying object or an apparatus (Aerial UE) provided on the flying object.

The NG-RAN 10 includes base stations 200 (referred to as “gNBs” or “NG-RAN nodes” in 5G systems), which are a type of network node. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

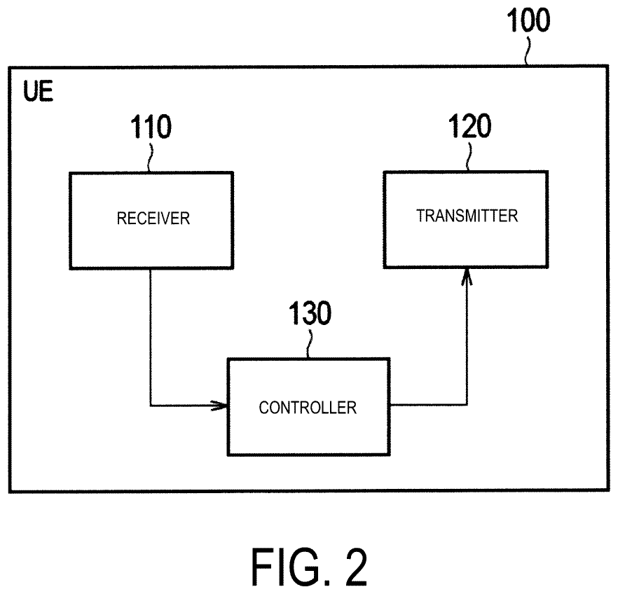

FIG. 2 is a diagram illustrating a configuration of the UE 100 (the user equipment) according to an embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. The operations of the UE 100 described above and to be described below may also be an operation under the control of the controller 130. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

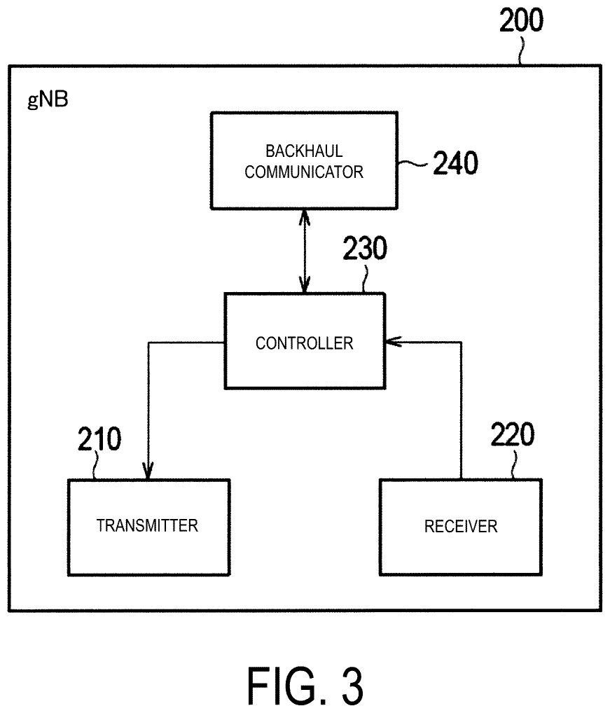

FIG. 3 is a diagram illustrating a configuration of the gNB 200 (network node) according to an embodiment. The gNB 200 includes a transmitter 210, a receiver 220, a controller 230, and a backhaul communicator 240. The transmitter 210 and the receiver 220 constitute a communicator that performs wireless communication with the UE 100. The backhaul communicator 240 constitutes a network communicator that performs communication with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. The operations of the gNB 200 described above and below may also be performed under the control of the controller 130. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface which is an interface between a base station and the core network. Note that the gNB 200 may include a central unit (CU) and a distributed unit (DU) (i.e., functions are divided), and the two units may be connected via an F1 interface, which is a fronthaul interface.

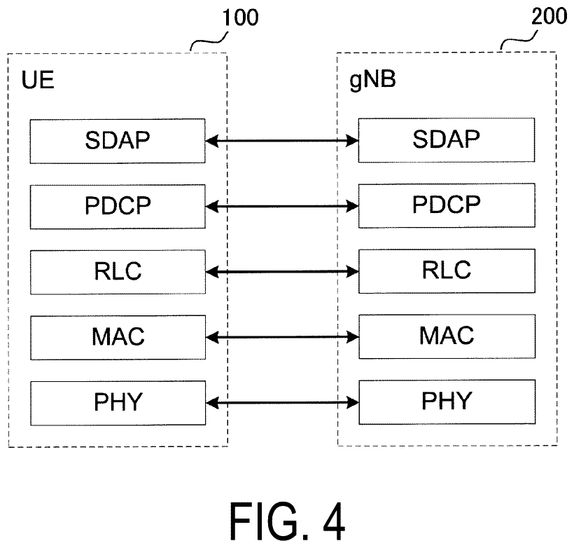

FIG. 4 is a diagram illustrating a configuration of a protocol stack of a radio interface of a user plane handling data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. The DCI transmitted from the gNB 200 is appended with Cyclic Redundancy Code (CRC) parity bits scrambled by the RNTI.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

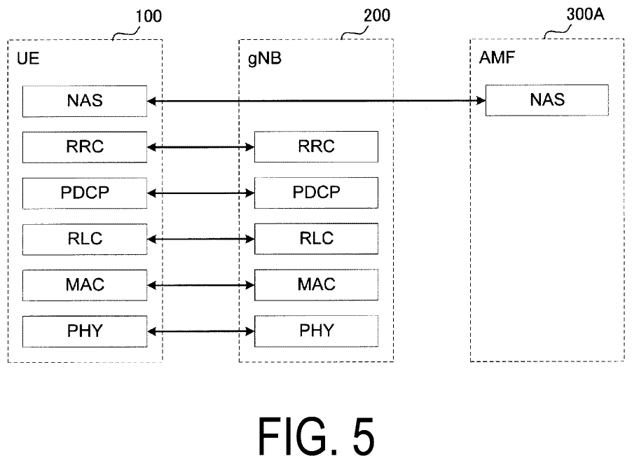

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300A. The UE 100 includes an application layer other than the protocol of the radio interface. A layer lower than the NAS is referred to as an Access Stratum (AS).

### (2) Overview of AI/ML Technology

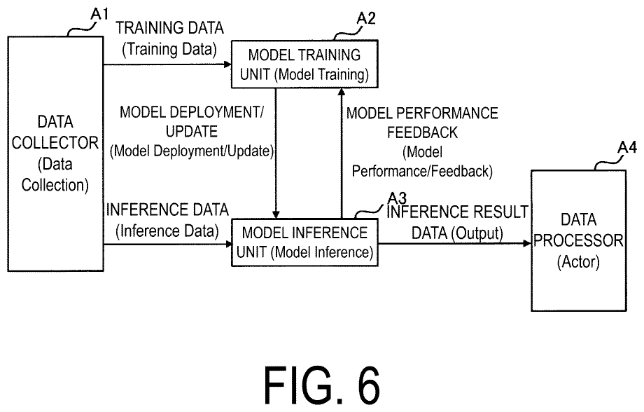

An overview of the AI/ML Technology will be described. FIG. 6 is a diagram illustrating a functional block configuration of the AI/ML technology in the mobile communication system 1 according to an embodiment.

The functional block configuration illustrated in FIG. 6 includes a data collector A1, a model training unit A2, a model inference unit A3, and a data processor A4.

The data collector A1 collects input data, specifically, training data and inference data, and outputs the training data to the model training unit A2 and outputs the inference data to the model inference unit A3. The data collector A1 may acquire data in the apparatus in which the data collector A1 is provided, as input data. The data collector A1 may acquire, as the input data, data in another apparatus.

The model training unit A2 performs model training (also referred to as “learning processing”). To be specific, the model training unit A2 optimizes parameters for the training model (hereinafter also referred to as a “model” or an “AI/ML model”) by machine learning using the training data, derives (generates or updates) a trained model, and outputs the trained model to the model inference unit A3. The model is data-driven algorithm in which a set of outputs is generated based on a set of inputs through application of the AI/ML technology. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score.

The model inference unit A3 performs model inference (also referred to as “inference processing). To be specific, the model inference unit A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. Here, various techniques for the model are used, such as linear regression analysis, neural network, and decision tree analysis. The above “y=ax+b” can be considered as a kind of the linear regression analysis. The model inference unit A3 may perform model performance feedback to the model training unit A2.

The data processor A4 receives the inference result data and performs processing that utilizes the inference result data.

### (3) Overview of Network Slicing Technology

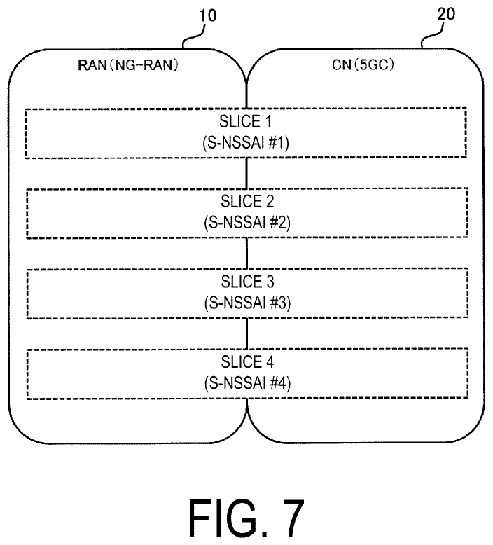

An overview of the network slicing technology is described. FIG. 7 is a diagram for describing an overview of the network slicing technology.

In the network slicing, the network 5 is logically divided into network slices (hereinafter, also simply referred to as “slices”). Each slice corresponds to a different service requirement. In the illustrated example, the network 5 includes four slices (slices 1 to 4).

A network slice includes a RAN part and a CN part. Support for the network slicing is based on the principle that traffic of different slices is handled by different protocol data unit (PDU) sessions. The network 5 can implement various network slices by scheduling and by providing different layer 1/layer 2 (L1/L2) configurations.

Each network slice is identified by Single-Network Slice Selection Assistance Information (S-NSSAI). Note that the NSSAI includes one S-NSSAI or a list of S-NSSAIs. The S-NSSAI has a mandatory Slice/Service Type (SST) field that identifies a slice type and an optional Slice Differentiator (SD) field that distinguishes between slices having the same SST field.

In a case where the NSSAI is provided by the NAS, the UE 100 provides the NSSAI for network slice selection to the network 5 (NG-RAN 10/gNB 200) through an RRC Setup Complete message. The network 5 can support a large number of slices, but the UE 100 need not support more than eight slices simultaneously. The NG-RAN 10 supports selection of the RAN part of the network slice by the NSSAI provided by UE 100 or 5GC 20. Note that one gNB 200 (NG-RAN node) can support a plurality of slices.

The NG-RAN 10 can support resource isolation between slices and allocate dedicated NG-RAN resources to a certain slice. Some Random Access Channel (RACH) resources are associated with a specific Network Slice AS Group (NSAG). The NSAG identifies an association with a slice or a set of slices. That is, the NSAG indicates a slice group including at least one slice. The NSAG is defined within a Tracking Area (TA) and is used for slice-based cell reselection and/or slice-based random access (slice-based RACH configuration).

### (4) Operation of Mobile Communication System

The operation of the mobile communication system 1 according to the embodiment is described.

### (4.1) Overview of Operation

Various parameters related to the network slice are considered to be able to be optimized by AI/ML by applying the AI/ML technology to the network slicing technology. However, no technology for the network 5 to collect data for such optimization is established, leading to difficulty in performing optimization related to the network slice.

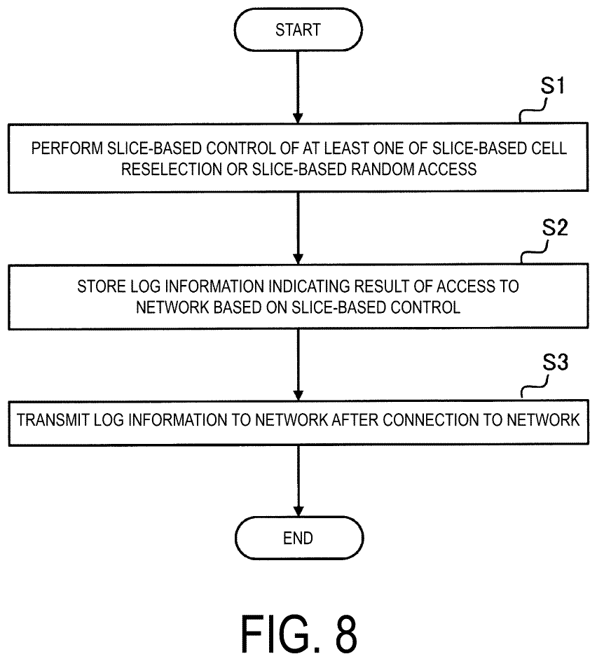

In the following embodiment, an operation for enabling optimization related to a network slice in the mobile communication system 1 will be described. FIG. 8 is a flowchart illustrating an overview of operation of the UE 100 in the mobile communication system 1 according to an embodiment.

In step S1, the UE 100 performs slice-based control of at least one of slice-based cell reselection that determines a frequency priority in consideration of a network slice or slice-based random access that selects a RACH configuration in consideration of a network slice. Here, the slice-based control is control for smoothing access to a network slice desired by the UE 100 (also referred to as a “desired network slice”).

To be more specific, in slice-based random access, the UE 100 can increase, for an NSAG corresponding to the desired network slice (NSAG with a high priority), the success rate of random accesses by applying the RACH configuration associated with the NSAG to the random accesses, and UE 100 can easily access (connect to) the network 5. An example of the operation of performing the slice-based random access will be mainly described in a first operation pattern described later.

In the slice-based cell reselection, the UE 100 applies, for the NSAG corresponding to the desired network slice (NSAG with a high priority), the frequency priority associated with the NSAG to the cell switching for the NSAG (NSAG with a high priority) corresponding to the desired network slice, and thus the UE 100 easily reselects a cell that provides (supports) the desired network slice. An example of the operation of performing the slice-based cell reselection will be mainly described in a second operation pattern described later.

In step S2, the UE 100 accesses the network 5 based on the slice-based control of step S1, and stores log information indicating a result of the access.

In the first operation pattern, the UE 100 stores, in response to the access (slice-based random access) being unsuccessful, first log information (hereinafter also referred to as “failure log information”) regarding the unsuccessful access. On the other hand, in the second operation pattern, the UE 100 stores, in response to the access being successful, second log information (hereinafter, also referred to as “success log information”) regarding the successful access.

In step S3, the UE 100 transmits the log information stored in step S2 to the network 5 after connection to the network 5.

According to such an operation, the network 5 can use the log information from the UE 100 as information for optimization related to the network slice, thus enabling optimization related to the network slice in the mobile communication system 1.

The UE 100 that performs such an operation includes the controller 130 that performs slice-based control of at least one of slice-based cell reselection that determines a frequency priority in consideration of a network slice or slice-based random access that selects a RACH configuration in consideration of the network slice, the controller 130 storing log information indicating a result of access to the network 5 based on the slice-based control, and the transmitter 120 that transmits the log information to the network 5 after connection to the network 5. On the other hand, the gNB 200 includes a receiver 220 that receives, from the UE 100 that has performed the slice-based control, log information indicating a result of access to the network 5 based on the slice-based control.

In the first operation pattern, the failure log information includes information indicating that the slice-based random access has been performed. For example, the failure log information includes at least one of the S-NSSAI or the NSAG ID, each of which is specified by the UE 100 to perform the slice-based random access. This enables the network 5 to determine which NSAG (which slice) is used as a target of the slice-based random access, which has resulted in the access failure. In the first operation pattern, the failure log information may include information indicating the RACH configuration used by the UE 100 in the slice-based random access. This enables the network 5 to determine which RACH configuration has caused an access failure in the slice-based random access.

In the second operation pattern, the success log information includes information indicating a connection delay time from when the UE 100 starts access (random access) to the network 5 until a state in which communication of a desired network slice is enabled. This enables, based on the success log information from the UE 100, the network 5 to determine the connection delay time when the slice-based control is applied and to determine the effect of the slice-based control.

Here, the state in which communication with the desired network slice is enabled may be a state in which the UE 100 receives an RRC message from the network 5 after starting access (in random access) to the network 5, or a state in which the UE 100 transmits an RRC message to the network 5. Alternatively, the state in which communication with the desired network slice is enabled may be a state in which the PDU session corresponding to the desired network slice is established.

### 4.2 First Operation Pattern

The first operation pattern is an operation pattern in which the UE 100 performs the slice-based random access. Note that, in the first operation pattern, the UE 100 may perform the slice-based cell reselection in addition to the slice-based random access.

Here, the slice-based random access will be described. The UE 100 needs to perform random access, for example, when transitioning from the RRC idle state to the RRC connected state. There are two types of random access, Contention-based Random Access (CBRA) and Contention-free Random Access (CFRA). In CBRA, the UE 100 selects one RACH preamble (also referred to as a “random access preamble”) from among a group of RACH preambles indicated by a system information block (SIB) broadcast from the gNB 200, and transmits the selected RACH preambles to the gNB 200. In this case, a collision of random access may occur because another UE 100 may transmit the same RACH preamble to the gNB 200.

The gNB 200 reserves some RACH resources for the UE 100 that utilizes a high priority slice by utilizing RACH resource partitioning in which the RACH resource is partitioned for use. The gNB 200 broadcasts the RACH configuration of the reserved RACH resource in the SIB in association with the NSAG. The UE 100 that utilizes the high priority slice selects the RACH configuration and performs random access using the reserved RACH resource. To be more specific, in a case where, in the UE 100, the NAS provides the AS with information of the NSAG for random access, the UE 100 can select the RACH configuration associated with the NSAG. This can prevent a collision of random access between the UE 100 that utilizes the high-priority slice and another UE 100.

However, in a case where a large number of UEs 100 that utilize the high priority slice exist in the same cell, a collision of random access may occur between the UEs 100 that utilize the high priority slice, leading to a failure in random access. Here, according to the RRC technical specification of 3GPP (TS38. 331), information regarding a random access failure can be transmitted from UE 100 to the network 5 as a Connection Establishment Failure report. However, since such a connection establishment failure report does not include information indicating whether the UE 100 has performed the slice-based random access, the network 5 fails to determine whether the UE 100 has performed the slice-based random access. The network 5 fails to determine which NSAG is associated with the RACH configuration applied by the UE 100.

In the first operation pattern, the UE 100 stores, in response to the slice-based random access being unsuccessful, failure log information including information indicating that the slice-based random access has been performed. Such failure log information may be information constituting a part of the connection establishment failure report. For example, the failure log information may include at least one of the NSAG ID or the S-NSSAI, each of which is specified by the UE 100 to perform the slice-based random access. The failure log information may include information indicating the RACH configuration used by the UE 100 in the slice-based random access.

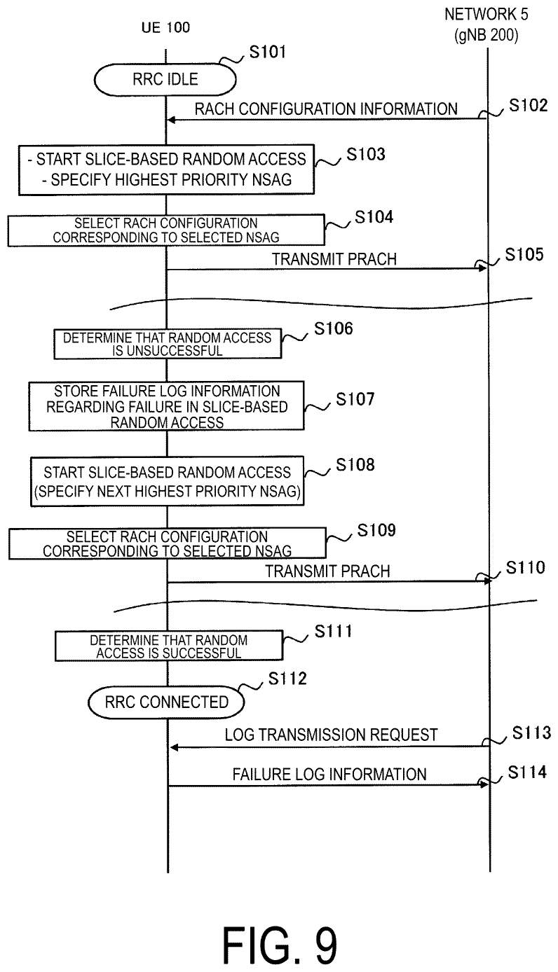

FIG. 9 is a diagram illustrating an example of the first operation pattern according to an embodiment.

In step S101, the UE 100 is in the RRC idle state (or RRC inactive state) in the cell (serving cell) of the gNB 200. The NAS of the UE 100 is assumed to have acquired information of the NSAG and the priority thereof from the network 5 (AMF 300A). The NAS of the UE 100 notifies the AS of such NSAG priority information.

In step S102, the gNB 200 broadcasts an SIB including the RACH configuration associated with the NSAG. The UE 100 receives the SIB. The SIB may include a plurality of RACH configurations associated with different NSAGs. The SIB may include a RACH configuration that is not associated with the NSAG.

In step S103, the UE 100 detects a trigger for random access, for example, generation of uplink data or reception of paging, and starts the slice-based random access (CBRA). Here, the AS of the UE 100 specifies the highest priority NSAG based on the NSAG priority information from the NAS.

In step S104, based on the SIB received in step S103, the UE 100 selects the RACH configuration a sociated with the NSAG specified in step S102.

In step S105, the UE 100 transmits, to the gNB 200, a RACH preamble (Msg1) based on the RACH configuration selected in step S104. For example, the UE 100 transmits, to the gNB 200, a RACH preamble selected from the group of RACH preambles indicated by the RACH configuration. The gNB 200 receives the RACH preamble. However, the gNB 200 may fail to successfully receive the RACH preamble. Alternatively, the gNB 200 may receive the same RACH preamble from another UE 100, resulting in a collision of random access.

In step S106, the UE 100 determines that the random access has failed. For example, the UE 100 may determine that the random access has failed, in response to not receiving a random access response (Msg2) from the gNB 200 within a certain period of time after transmitting the RACH preamble. After receiving the random access response, the UE 100 may determine that the random access has failed in response to failing to successfully receive a contention resolution message (Msg4) from the gNB 200.

In step S107, the UE 100 generates failure log information regarding a slice-based random access failure, and stores the generated failure log information. The failure log information includes at least one of the following pieces of information 1) to 5).
1) information indicating that the slice-based random access has been performed (failed);
2) information indicating the NSAG specified in step S103 (NSAG ID);
3) S-NSSAI of the desired network slice;
4) ID (index) of the RACH configuration;
5) ID (index) indicating a partition configuration of the RACH resource.

The UE 100 may store the connection establishment failure report including the failure log information. The connection establishment failure report may include at least one of the cell ID of a cell to which the UE 100 has failed to access, a measurement result for the cell, UE location information, or a list (PerRAAttemptInfoList) of information for each attempt of random access (random access attempt). Here, the UE 100 may include the failure log information regarding the slice-based random access failure in a corresponding entry of the list (PerRAAttemptInfoList).

Note that the failure log information may further include information indicating whether the UE 100 has performed the slice-based cell reselection.

In step S108, UE 100 may specify the next highest priority NSAG and start the random access procedure anew (in the illustrated example, the slice-based random access). For example, the AS of the UE 100 may specify the second highest priority NSAG based on the NSAG priority information from the NAS. Alternatively, the UE 100 may initiate a non-slice-based random access procedure in a case where the second highest priority NSAG does not exist.

In step S109, the UE 100 selects the RACH configuration associated with the NSAG specified in step S102 based on the SIB received in step S108.

In step S110, the UE 100 transmits, to the gNB 200, the RACH preamble (Msg1) based on the RACH configuration selected in step S109. For example, the UE 100 transmits, to the gNB 200, a RACH preamble selected from the group of RACH preambles indicated by the RACH configuration. The gNB 200 receives the RACH preamble.

In step S111, the UE 100 determines that the random access is successful. For example, the UE 100 may determine that the random access is successful in response to receiving the random access response (Msg2) from the gNB 200 within a certain period of time after transmitting the RACH preamble. After receiving the random access response, the UE 100 may determine that the random access is successful in response to the successful reception of the contention resolution message (Msg4) from the gNB 200.

In step S112, the NCR-UE 100B transitions from the RRC idle state (or the RRC inactive state) to the RRC connected state. The UE 100 may transmit an RRC setup complete message to the gNB 200. Here, the UE 100 may transmit the RRC setup complete message including an indicator indicating that the UE holds the failure log information (connection establishment failure report).

In step S113, the gNB 200 transmits, to the UE 100, a message (UE Information Request message) requesting transmission of the failure log information (connection establishment failure report).

In Step S114, in response to the reception of the UE Information Request message, UE 100 transmits, to the gNB 200, a message (UE Information Response message) including the failure log information (connection establishment failure report). The gNB 200 receives the UE Information Response message to acquire the failure log information (connection establishment failure report).

### 4.3 Second Operation Pattern

The second operation pattern is an operation pattern in which the UE 100 performs the slice-based cell reselection. Note that, in the second operation pattern, the UE 100 may perform the slice-based random access in addition to the slice-based cell reselection. The operation of the first operation pattern may be combined with the second operation pattern for implementation.

Here, the slice-based random access will be described. The UE 100 in the RRC idle state or the RRC inactive state performs cell reselection to switch from the current serving cell to another serving cell. In general cell reselection, the UE 100 performs the cell reselection based on the frequency priority and the measurement value of radio quality without considering the network slice.

Thus, the UE 100 may reselect a cell in which the desired network slice is not supported. In this case, after transitioning to the RRC connected state in the serving cell, the UE 100 may be handed over from the serving cell to a cell in which the desired network slice is supported, or the RRC connection may be released. As a result, a delay (connection delay) may occur until the UE 100 is brought into a state in which communication with the desired network slice is enabled.

In the slice-based cell reselection, the frequency priority can be determined in consideration of the network slice, allowing the UE 100 to easily reselect the cell in which the desired network slice is supported. To be more specific, in a case where, in the UE 100, the NAS provides the AS with the information of the NSAG for cell reselection, UE 100 can determine the slice-based frequency priority as the frequency priority of a frequency associated with the NSAG. Note that the slice-based cell reselection information can be included in SIB type 16 (SIB 16) or an RRC release message. The slice-based cell reselection information can include the frequency priority for each frequency and for each NSAG, and a list of cells for which the slice of the NSAG is supported or not supported.

However, the network 5 fails to determine the effect of shortening the connection delay due to the slice-based cell reselection. Thus, for example, in a case where an Ultra-Reliable and Low Latency Communications (URLLC) slice and/or a maximum allowable delay time until slice communication starts are defined, a problem is that the network 5 has difficulty in checking whether a demanded quality of service (QoS) is satisfied and/or determining the cause of a connection delay, optimizing the connection delay, and the like.

In the second operation pattern, the UE 100 stores, in response to access to the network 5 being successful, success log information regarding the successful access. The success log information includes information indicating the connection delay time from when the UE 100 starts access (random access) to the network 5 until the state in which communication of a desired network slice is enabled. This enables, based on the success log information, the network 5 to determine the effect of shortening the connection delay due to the slice-based cell reselection.

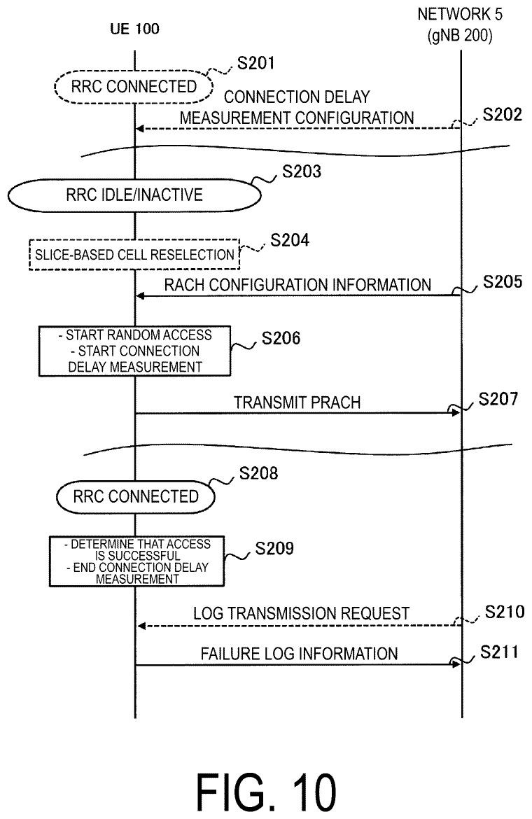

FIG. 10 is a diagram illustrating an example of the second operation pattern according to an embodiment.

In step S201, the UE 100 may be in the RRC connected state in the cell of the gNB 200.

In step S202, the gNB 200 (or AMF 300A) may transmit, to the UE 100, an RRC message (or NAS message) for configuring connection delay measurement for the UE 100. The UE 100 receives the message. The configuration may include at least one of information indicating a target session (for example, a PDU session ID), information indicating a target slice (for example, the NSAG or S-NSSAI), or information indicating a measurement stopping condition.

In step S203, the UE 100 transitions to the RRC idle state or the RRC inactive state and camps on the serving cell.

In step S204, the UE 100 may perform the slice-based cell reselection to switch the serving cell.

In step S205, the gNB 200 transmits an SIB including the RACH configuration. The UE 100 receives the SIB. The UE 100 receives the SIB. The SIB may include the RACH configuration associated with the NSAG, as is the case with the first operation pattern.

In step S206, the UE 100 detects a random access trigger, for example, the generation of uplink data or the reception of paging, and starts random access to the network 5. Here, the UE 100 starts the connection establishment delay measurement. The UE 100 may start a measurement timer (count-up timer). The UE 100 may store a timestamp of the access start time.

In step S207, UE 100 transmits the RACH preamble (Msg1) to the gNB 200 based on the SIB (RACH configuration) received in step S205. The UE 100 may start the connection establishment delay measurement at the time of transmission of the RACH preamble.

Note that after the connection establishment delay measurement is started, the following events may occur, but the UE 100 continues the connection establishment delay measurement:
connection establishment failure;
RACH failure (random access failure);
handover (assuming that the serving cell does not support the desired slice);
carrier aggregation is configured and a secondary cell (SCell) is activated (assuming that the high frequency SCell supports the desired slice);
The dual connectivity is configured, and a secondary cell group (SCG)/SCell is activated (assuming that the desired slice is supported by the high-frequency SCG).

The UE 100 may start the connection establishment delay measurement only for a specific PDU session. The specific PDU session may be associated with a specific slice. For example, the specific slice may be a URLLC slice or a slice with a request for a connection establishment delay (QoS request). The specific PDU session or the specific slice may be configured by the gNB 200 or the AMF 300A for the UE 100 (step S202).

In step S208, the UE 100 transitions to the RRC connected state. The UE 100 may transition to the RRC connected state in response to receiving the Msg4 (e.g., the RRC setup message) from the gNB 200.

In step S209, the UE 100 ends, in response to the access to the network 5 being successful and the communication of the desired network slice being enabled, the connection establishment delay measurement and stores the success log information including the information indicating the measured connection establishment delay time. The end of the connection establishment delay measurement may correspond to stopping the measurement timer (count-up timer). The end may correspond to storing a timestamp when the connection establishment is successful. The UE 100 may acquire the measurement value of the measurement timer (count-up timer) and/or the timestamp (start timestamp, end timestamp) as the connection establishment delay time information. The UE 100 may acquire a differential value between the start timestamp and the end timestamp as the connection establishment delay time information.

The UE 100 may end the connection establishment delay measurement when any one of the following events 1) to 6) occurs:
1) receiving the Msg4 (e.g., the RRC setup message) from the gNB 200;
2) transmitting an Msg5 (e.g., the RRC setup complete message) to the gNB 200;
3) receiving an acknowledgement (ACK) of the Msg5 from the gNB 200;
4) receiving the RRC setup message, an RRC resume message, or an RRC reconfiguration message from the gNB 200, leading to configuration (establishment) of a PDU session associated with the desired slice (NSAG or S-NSSAI). Note that the PDU session ID is notified in the SDAP configuration in a radio bearers configuration (Radio Bearers Config) from the gNB 200. The Radio Bearer Config may be included in the RRC setup message, the RRC resume message, or the RRC Reconfiguration message. PDU sessions are mapped to network slices (instances) on a one-to-one basis and vice versa;
5) starting data communication using a data bearer associated with the PDU session; and
6) transmitting, to the gNB 200, a response message (RRC setup complete message, RRC resume complete message, or RRC reconfiguration complete message) for the RRC setup message, the RRC resume message, or the RRC reconfiguration message.

The UE 100 may transmit, to the gNB 200, an indicator indicating that the UE 100 holds the connection establishment delay time information (success log information), for example, by including the indicator in the Msg5 (for example, the RRC setup complete message).

In step S210, the gNB 200 may transmit, to the UE 100, the message (e.g., the UE Information Request message) requesting transmission of the connection establishment delay time information (success log information).

In step S211, UE 100 transmits, to the gNB 200, a message (e.g., the UE Information Response message, a UE assistance information message, or a measurement report message) including the connection establishment delay time information (success log information). The gNB 200 receives the message to acquire the connection establishment delay time information (success log information).

Note that the connection establishment delay time information (success log information) may include at least one of the following pieces of additional information 1) and 2).

1) Cell Information of a Cell on which the UE 100 is Camped.

The cell information may be the cell ID of the cell at the start time of the access. The cell information may be a list of the IDs of cells on which the UE 100 has been camped in the RRC idle state or the RRC connected state. The cell information may include information regarding whether the cell is camped on according to the slice-based cell reselection. The information may be information regarding whether the cell is camped on according to cell reselection that is not slice-based. The cell information may include information indicating the priority rank of an NSAG on which the cell was camped.

### 2) Desired Slice Information (S-NSSAI or NSAG Indicating the Desired Network Slice of the UE 100).

### (5) Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an Integrated Access and Backhaul (IAB) node. The base station may be a distributed unit (DU) of the IAB node. The user equipment (terminal apparatus) may be a relay node such as an IAB node or a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each piece of the processing performed by the communication apparatus (e.g., UE 100 or gNB 200) may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for performing each piece of processing performed by the communication apparatus may be integrated, and at least part of the communication apparatus may be configured as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

As used in this disclosure, the terms “based on” and “depending on” do not mean “based only on” or “depending only on”, unless otherwise specified. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

The present application claims priority to Japanese Patent Application No. 2023-133587 (filed on Aug. 18, 2023), the contents of which are incorporated herein by reference in their entirety.

### (6) Supplementary Notes

Features relating to the embodiments described above are described below as supplementary notes.

### Supplementary Note 1

A communication method executed by a user equipment configured to communicate with a network of a mobile communication system, the communication method including the steps of: performing slice-based control of at least one of slice-based cell reselection that determines a frequency priority in consideration of a network slice or slice-based random access that selects a random access channel (RACH) configuration in consideration of the network slice;
storing log information indicating a result of access to the network based on the slice-based control; and
transmitting the log information to the network after connection to the network.

### Supplementary Note 2

The communication method according to Supplementary Note 1, wherein
the step of performing slice-based control includes a step of performing the slice-based random access,
the step of storing includes a step of storing, in response to the slice-based random access being unsuccessful, first log information regarding the unsuccessful slice-based random access as the log information, and
the first log information includes information indicating that the slice-based random access has been performed.

### Supplementary Note 3

The communication method according to Supplementary Note 2, wherein
the first log information includes at least one of a Network Slice AS Group (NSAG) ID or Single Network Slice Selection Assistance information (S-NSSAI), each of which is specified by the user equipment to perform the slice-based random access.

### Supplementary Note 4

The communication method according to Supplementary Note 2 or 3, wherein the first log information includes information indicating a random access channel (RACH) configuration used by the user equipment in the slice-based random access.

### Supplementary Note 5

The communication method according to any one of Supplementary Notes 1 to 4, wherein the step of performing slice-based control includes a step of performing the slice-based cell reselection,
the step of storing includes a step of storing, in response to the access to the network being successful, second log information regarding the successful access as the log information, and the second log information includes information indicating a connection delay time from when the access is started until a state in which communication with a desired network slice is enabled.

### Supplementary Note 6

The communication method according to Supplementary Note 5, wherein the state in which communication of a desired network slice is enabled is a state in which the user equipment receives a radio resource control (RRC) message from the network or a state in which the user equipment transmits the RRC message to the network.

### Supplementary Note 7

The communication method according to Supplementary Note 5, wherein
the state in which communication of a desired network slice is enabled is a state in which a protocol data unit (PDU) session corresponding to the desired network slice is established.

### Supplementary Note 8

A user equipment configured to communicate with a network of a mobile communication system, the user equipment including:
a controller configured to perform slice-based control of at least one of slice-based cell reselection that determines a frequency priority in consideration of a network slice or slice-based random access that selects a random access channel (RACH) configuration in consideration of the network slice, the controller being configured to store log information indicating a result of access to the network based on the slice-based control; and a transmitter configured to transmit the log information to the network after connection to the network.

### Supplementary Note 9

A network node configured to communicate with a user equipment of a mobile communication system, the network node including:
a receiver configured to receive, from a user equipment that has performed slice-based control of at least one of slice-based cell reselection that determines a frequency priority in consideration of a network slice or slice-based random access that selects a random access channel (RACH) configuration in consideration of the network slice, log information indicating a result of access to the network based on the slice-based control.

### REFERENCE SIGNS

1: Mobile communication system
5: Network
10: RAN (NG-RAN)
20: CN (5GC)
100: UE
110: Receiver
120: Transmitter
130: Controller
200: gNB
210: Transmitter
220: Receiver
230: Controller
240: Backhaul communicator
A1: Data collector
A2: Model training unit
A3: Model inference unit
A4: Data processor

1. A communication method executed by a user equipment configured to communicate with a network of a mobile communication system, the communication method comprising:
performing slice-based control of at least one of slice-based cell reselection that determines a frequency priority in consideration of a network slice or slice-based random access that selects a random access channel (RACH) configuration in consideration of the network slice;
storing log information indicating a result of access to the network based on the slice-based control; and
transmitting the log information to the network after connection to the network.

2. The communication method according to claim 1, wherein
the performing slice-based control includes performing the slice-based random access,
the storing includes storing, in response to the slice-based random access been unsuccessful, first log information regarding the unsuccessful slice-based random access as the log information, and
the first log information includes information indicating that the slice-based random access has been performed.

3. The communication method according to claim 2, wherein the first log information includes at least one of a Network Slice AS Group (NSAG) ID or Single Network Slice Selection Assistance information (S-NSSAI), each of which is specified by the user equipment to perform the slice-based random access.

4. The communication method according to claim 2, wherein the first log information includes information indicating a random access channel (RACH) configuration used by the user equipment in the slice-based random access.

5. The communication method according to claim 1, wherein
the performing slice-based control includes performing the slice-based cell reselection,
the storing includes storing, in response to the access to the network being successful, second log information regarding the successful access as the log information, and
the second log information includes information indicating a connection delay time from when the access is started until a state in which communication with a desired network slice is enabled.

6. The communication method according to claim 5, wherein the state in which communication of a desired network slice is enabled is a state in which the user equipment receives a radio resource control (RRC) message from the network or a state in which the user equipment transmits the RRC message to the network.

7. The communication method according to claim 5, wherein the state in which communication of a desired network slice is enabled is a state in which a protocol data unit (PDU) session corresponding to the desired network slice is established.

8. A user equipment configured to communicate with a network of a mobile communication system, the user equipment comprising:
a controller configured to perform slice-based control of at least one of slice-based cell reselection that determines a frequency priority in consideration of a network slice or slice-based random access that selects a random access channel (RACH) configuration in consideration of the network slice, the controller being configured to store log information indicating a result of access to the network based on the slice-based control; and
a transmitter configured to transmit the log information to the network after connection to the network.

9. A network node configured to communicate with a user equipment of a mobile communication system, the network node comprising:
a receiver configured to receive, from a user equipment that has performed slice-based control of at least one of slice-based cell reselection that determines a frequency priority in consideration of a network slice or slice-based random access that selects a random access channel (RACH) configuration in consideration of the network slice, log information indicating a result of access to the network based on the slice-based control.
